(19) United States
(12) Patent Application Publication
(10) Pub. No.: US 2014/0170353 A1
(43) Pub. Date: Jun. 19, 2014

(54) Blow Molded Composite Component and Method

(71) Applicant: Ticona LLC, Florence, KY (US)

(72) Inventors: Andrew Kreager, Mason, OH (US); Richard Novaco, Auburn Hills, MI (US); Robert E. Newell, Auburn Hills, MI (US)

(73) Assignee: Ticona LLC, Florence, KY (US)

(21) Appl. No.: 14/102,963

(22) Filed: Dec. 11, 2013

Related U.S. Application Data
(60) Provisional application No. 61/737,979, filed on Dec. 17, 2012.

(51) Int. Cl. B29C 49/22

(52) U.S. Cl. CPC B29C 49/22
USPC 428/36.91; 264/516; 428/301.4

(57) ABSTRACT

Composite components and methods for forming composite components are provided. A method includes inserting a continuous fiber reinforced thermoplastic tape into a molding device, and feeding a parison into the molding device. The parison includes a thermoplastic material. The method further includes blow molding the parison within the molding device such that the parison bonds with the tape, forming the composite component. A composite component includes a blow molded inner layer comprising a thermoplastic material. The composite component further includes an outer layer bonded to the inner layer during blow molding of the inner layer. The outer layer includes a continuous fiber reinforced thermoplastic tape.

### CROSS REFERENCE TO RELATED APPLICATIONS

The present application claims filing benefit of U.S. Provisional Patent application 61/737,979 having a filing date of Dec. 17, 2012, which is incorporated by reference herein in its entirety.

### BACKGROUND OF THE INVENTION

Blow molding has been utilized for a number of years to form a variety of hollow plastic parts. It has proven effective to form single layer as well as multilayer materials and, with more recent advances, has been used to form a variety of complex shapes, for instance via 3D blow molding techniques. The versatility of blow molding processes is providing a route to the formation of multi-functional, one-piece blow molded components that can reduce weight and simplify assembly of consumer goods as well as manufacturing and production devices.

Many of the applications that could benefit from the utilization of blow molded components are quite demanding, and require components that can withstand a variety of both chemical and mechanical insults. For example, components for use in transport and transportation applications should be able to provide a long life under operating conditions that include temperature fluctuations as well as movement during use. Thus, materials generally require both strength and flexibility. Moreover, materials should be resistant to and impermeable to fluids that may be encountered during use such as oil, gas, coolants, water, air, etc. that may also be heated or cooled during use.

Further, various limitations have been recognized with respect to currently known blow molding techniques. For example, current technologies allow for the formation of single or multiple layer blow molded components. The various layers and materials thereof of multiple layer components allow some tailoring such that the final component provided desired, targeted properties. However, such tailoring is limited, and the required blow molding machinery and techniques are complex, expensive, and time consuming.

According, improved composite components and methods for forming such components are desired in the art. In particular, blow molded components and methods that provide blow molded components having improved targeted properties, such as targeted, localized reinforcement, would be advantageous.

### SUMMARY OF THE INVENTION

In according with one embodiment of the present disclosure, a method for forming a composite component is disclosed. The method includes inserting a continuous fiber reinforced thermoplastic tape into a molding device, and feeding a parison into the molding device. The parison includes a thermoplastic material. The method further includes blow molding the parison within the molding device such that the parison bonds with the tape, forming the composite component.

In accordance with another embodiment of the present disclosure, a composite component is disclosed. The composite component includes a blow molded inner layer comprising a thermoplastic material. The composite component further includes an outer layer bonded to the inner layer during blow molding of the inner layer. The outer layer includes a continuous fiber reinforced thermoplastic tape.

Other features and aspects of the present invention are set forth in greater detail below.

### BRIEF DESCRIPTION OF THE FIGURES

The present disclosure may be better understood with reference to the following figures:

FIG. 1 illustrates a composite component according to one embodiment of the present disclosure, wherein the composite component is a tubular component;

FIG. 2 provides a cross-sectional view of the composite component of FIG. 1;

FIG. 3 illustrates a tubular member including a tubular component according to one embodiment of the present disclosure;

FIG. 4 illustrates a tubular member including a tubular component according to another embodiment of the present disclosure;

FIG. 5 illustrates a composite component according to one embodiment of the present disclosure, wherein the composite component is a pressure vessel;

FIGS. 6 through FIG. 10 illustrate a blow molding process as may be utilized in forming a composite component according to one embodiment of the present disclosure;

FIG. 11 illustrates a continuous blow molding process as may be utilized in forming a composite component according to another embodiment of the present disclosure;

FIG. 12 is a perspective view of a tape in accordance with one embodiment of the present disclosure; and

FIG. 13 is a cross-sectional view a tape in accordance with one embodiment of the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to composite components, and methods for forming composite components. Specifically, the present disclosure is directed to the use of blow molding to form composite components. The resulting blow molding components include an inner blow molded layer. Further, such components include an outer layer that is bonded to the inner layer during the blow molding process. The outer layer provides reinforcement to the inner blow molded layer. The outer layer may be, for example, a sleeve or a patch, and may be provided at targeted, localized locations on the inner layer to provide localized reinforcement of the inner layer as required. For example, the outer layer may be located on predetermined vulnerable portions of the inner layer, such as portions of relatively higher stress during use, to provide local reinforcement of such portions. Bonding of the outer layer to the inner layer during the blow molding process is particularly advantageous, as it allows for efficient forming of the resulting composite component.

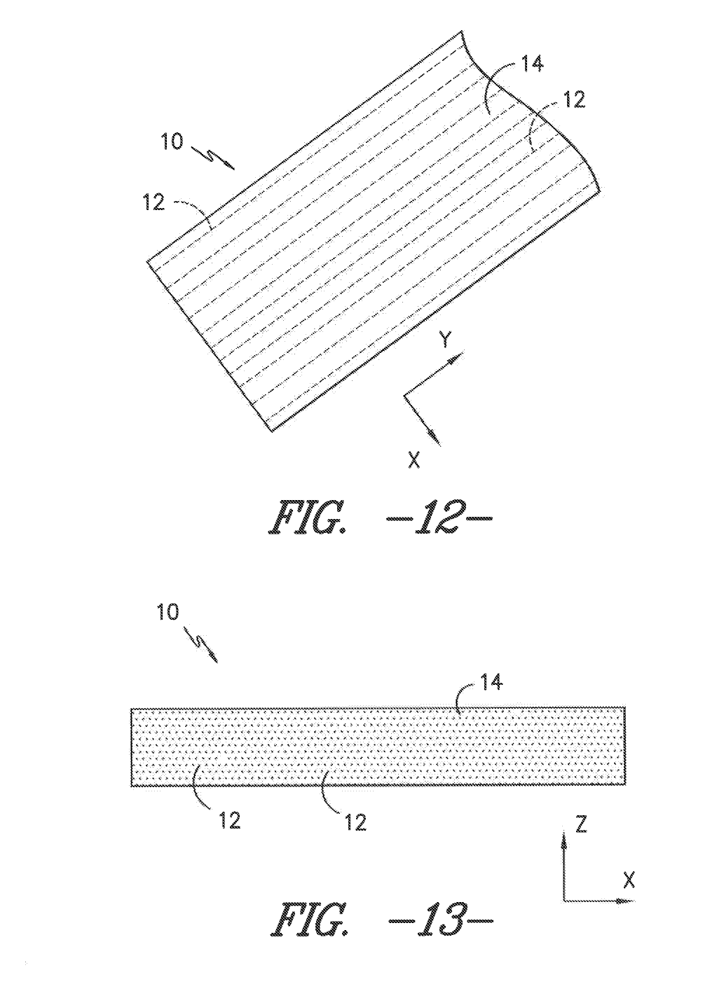

The outer layer according to the present disclosure may be formed from a continuous fiber reinforced thermoplastic tape, as shown in FIGS. 12 and 13. Such tapes 10, and the use of continuous fibers 12 embedded in a thermoplastic material 14, are particularly advantageous in reinforcement applications. Further, in exemplary embodiments, the blow molded inner layer may be formed from a thermoplastic material. Bonding of the outer layer and inner layer may be facilitated by the choice of materials utilized for the layers.

As discussed, in exemplary embodiments, the various components of a composite component according to the present disclosure, such as the inner layer and the tapes 10 forming the outer layer, are formed from thermoplastic materials 14, 22. Suitable thermoplastic materials for use according to the present disclosure include, for instance, polyolefins (e.g., polypropylene, propylene-ethylene copolymers, etc.), polyesters (e.g., polybutylene terephalate (“PBT”)), polycarbonates, polyamides (e.g., PA12, Nylon™), polyether ketones (e.g., polyether ether ketone (“PEEK”)), polyetherimides, polyarylene ketones (e.g., polyphenylene diketone (“PPDK”)), liquid crystal polymers, polyarylene sulfides (e.g., polyphenylene sulfide (“PPS”), poly(biphenylene sulfide ketone), poly(phenylene sulfide diketone), poly(biphenylene sulfide), etc.), fluoropolymers (e.g., polytetrafluoroethylene-perfluoromethylvinylether polymer, perfluoro-alkoxyalkane polymer, petrafluoroethylene polymer, ethylene-tetrafluoroethylene polymer, etc.), polyacetals, polyurethanes, polycarbonates, styrenic polymers (e.g., acrylonitrile butadiene styrene (“ABS”)), polyoxymethylene (“POM”), and so forth.

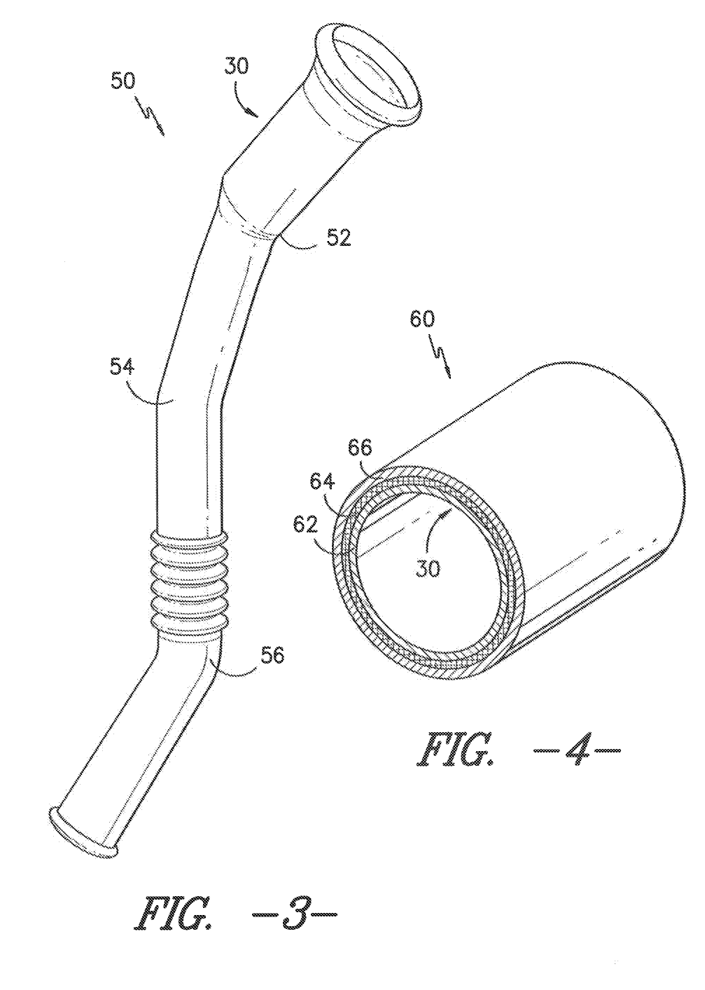

Further, the thermoplastic materials 14 may include a plurality of fibers 12 embedded therein. Impregnation of a thermoplastic material with a plurality of fibers may be performed utilizing any suitable processes and/or apparatus, such as suitable impregnation and/or pultrusion processes and/or apparatus. For example, as discussed, the outer layer may be formed from a continuous fiber reinforced thermoplastic tape. Thus, continuous fibers may be embedded in the thermoplastic material, although it should be understood that long fibers may additionally be included therein. Further, as shown in FIG. 2, the inner layer may be formed from a thermoplastic material 22. The thermoplastic material 22 of the inner layer, and the parison that forms the inner layer as discussed below, may be the same as the thermoplastic material 14 of the outer layer and tapes 10 thereof, or may be different. In some embodiments, the inner layer may be free from fibers. In other embodiments, however, the inner layer may further include a plurality of fibers 24 embedded therein. Such fibers may be long fibers or continuous fibers.

As used therein, the term “long fibers” generally refers to fibers, filaments, yarns, or rovings that are not continuous, and as opposed to “continuous fibers” which generally refer to fibers, filaments, yarns, or rovings having a length that is generally limited only by the length of a part.

The fibers 12, 24 dispersed in the thermoplastic material 14, 22 may be formed from any conventional material known in the art, such as metal fibers, glass fibers (e.g., E-glass, A-glass, C-glass, D-glass, AR-glass, R-glass, S-glass such as S1-glass or S2-glass), carbon fibers (e.g., graphite), boron fibers, ceramic fibers (e.g., alumina or silica), aramid fibers (e.g., Kevlar® marketed by E. I. DuPont de Nemours, Wilmington, Del.), synthetic organic fibers (e.g., polyamide, polyethylene, paraphenylene, terephthalamide, polyethylene terephthalate and polyphenylene sulfide), and various other natural or synthetic inorganic or organic fibrous materials known for reinforcing polymer compositions. Glass fibers, carbon fibers, and aramid fibers are particularly desirable. In exemplary embodiments, continuous fibers 12 dispersed in a resulting tape may be generally unidirectional, as shown in FIGS. 12 and 13.

Referring to FIGS. 12 and 13, for example, embodiments of a tape 10 are shown that contain continuous fibers 12 that are generally evenly distributed therein. As shown in FIG. 12, in exemplary embodiments, the fibers extend generally unidirectionally, such as along a longitudinal axis of the tape 10. Such tapes 10 may be utilized to form the outer layer of a composite component according to the present disclosure.

A relatively high percentage of fibers 12 may be employed in a resulting continuous fiber reinforced thermoplastic tape 10 to provide enhanced strength properties. For instance, fibers 12 typically constitute from about 25 wt. % to about 90 wt. %, in some embodiments from about 30 wt. % to about 75 wt. %, and in some embodiments, from about 35 wt. % to about 70 wt. % of the tape 10 and material thereof. Likewise, polymer(s) typically constitute from about 20 wt. % to about 75 wt. %, in some embodiments from about 25 wt. % to about 70 wt. %, and in some embodiments, from about 30 wt. % to about 65 wt. % of the tape 10. Such percentage of fibers may additionally or alternatively by measured as a volume fraction. For example, in some embodiments, a tape 10 or material thereof may have a fiber volume fraction between approximately 25% and approximately 80%, in some embodiments between approximately 30% and approximately 70%, in some embodiments between approximately 40% and approximately 60%, and in some embodiments between approximately 45% and approximately 55%.

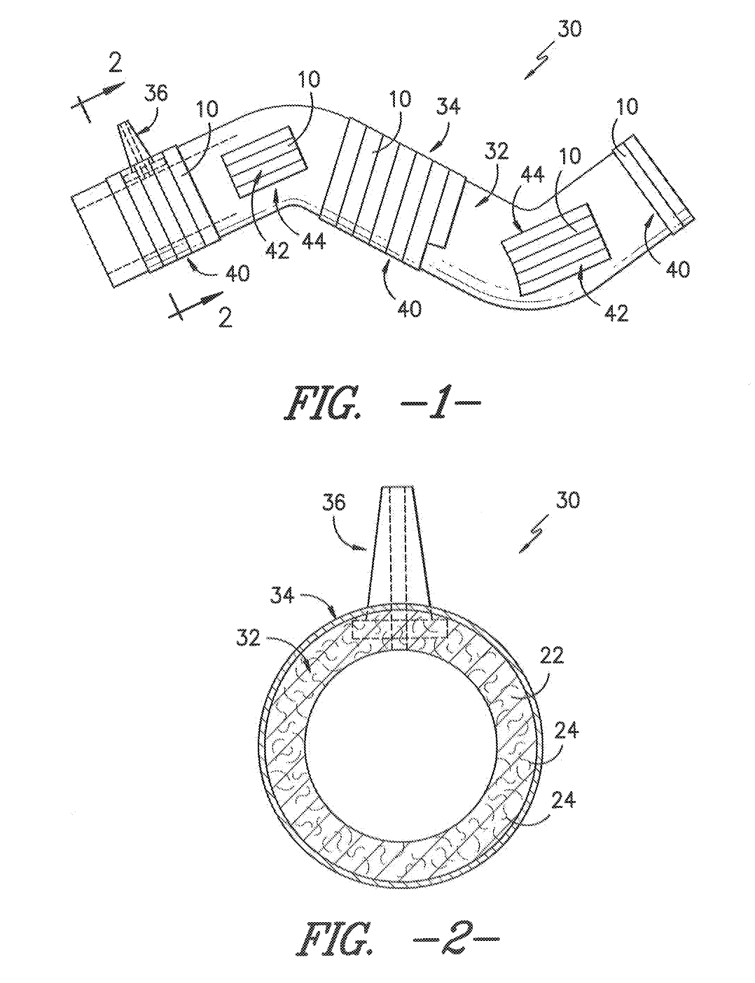

FIGS. 1 through 5 illustrate various embodiments of composite components 30 formed according to the present disclosure. FIGS. 1 and 2, for example, illustrate one embodiment wherein the composite component 30 is a tubular member. As shown, the composite component 30 in these embodiments includes an inner layer 32 and an outer layer 34 which includes a plurality of separate tapes 10. As shown, the composite component 30 may further include an insert 36, at least a portion of which is disposed between the inner layer 32 and the outer layer 34.

FIGS. 1 and 2 illustrate various embodiments of the tapes 10 utilized to form the outer layer 34. In some embodiments, for example, a tape 10 may be formed into a sleeve 40, which may generally wrap entirely around the periphery of the inner layer 32. Such tapes 10 may be wrapped peripherally, as shown by the sleeve 40 illustrated on the left side of the component 30 of FIG. 2, or helically, as shown by the sleeve 40 illustrated on the right side of the component 30 of FIG. 2, or at any other suitable orientation. Further, multiple layers of tapes 10 having generally similar or different orientations may be utilized.

In other embodiments, as further shown in FIGS. 1 and 2, a tape 10 may be formed into a patch 42, which may generally wrap only partially around the periphery of the inner layer 32. Such patches 42 may be applied at any suitable orientation, and may include any suitable number and layers of tapes 10.

In exemplary embodiments, a tape 10, such as a sleeve 40 or patch 42 forming the outer layer 34, may be located on the inner layer 32 to provide local reinforcement to a predetermined vulnerable portion 44 of the inner layer 32 and composite component 30. Such predetermined vulnerable portion 44 may be a portion of the component 30 which, due to for example size or shape, has a generally increased vulnerability to stress, and thus may be considered a failure point for component 30. For example, predetermined vulnerable portions 44 are illustrated at bends in the component 30 shown in FIG. 1, where stresses are likely to be increased. Such predetermined vulnerable portion 44 may additionally or alternatively be a portion of the component 30 which is, due to for example location, subject to increased loading, external abuse, etc., during use. For example, a predetermined vulnerable portion 44 is additionally shown at an end of the component 30, where the component is designed to be coupled to other components and thus will experience increased stress due to coupling. The location of a tape 10 over a predetermined vulnerable portion 44 may provide targeted, local reinforcement of the predetermined vulnerable portion 44, thus reducing the risk of damage or failure of the component 30.

As further shown in FIGS. 1 and 2, a component 30 may further include an insert 36. The insert may protrude from the component 30, as shown in FIGS. 1 and 2, or be positioned within the component 30, as required. The insert 30 may have any suitable shape or size and may be formed from any suitable material. The insert 30, or portions thereof, may be located within the inner layer 32 or between the inner layer 32 and outer layer 34. A tape 10, such as a sleeve 40 or patch 42, may be located to provide local reinforcement to the insert 36. As shown, for example, a tape 10 may be located over at least a portion of the insert 36, such as a portion that does not protrude from the component 30. The tape 10 may reinforce the component 30 at the location of the insert 30, thus reducing or preventing damage to the insert 30 or component 30 and/or reducing or preventing the risk of the insert breaking from the component 30.

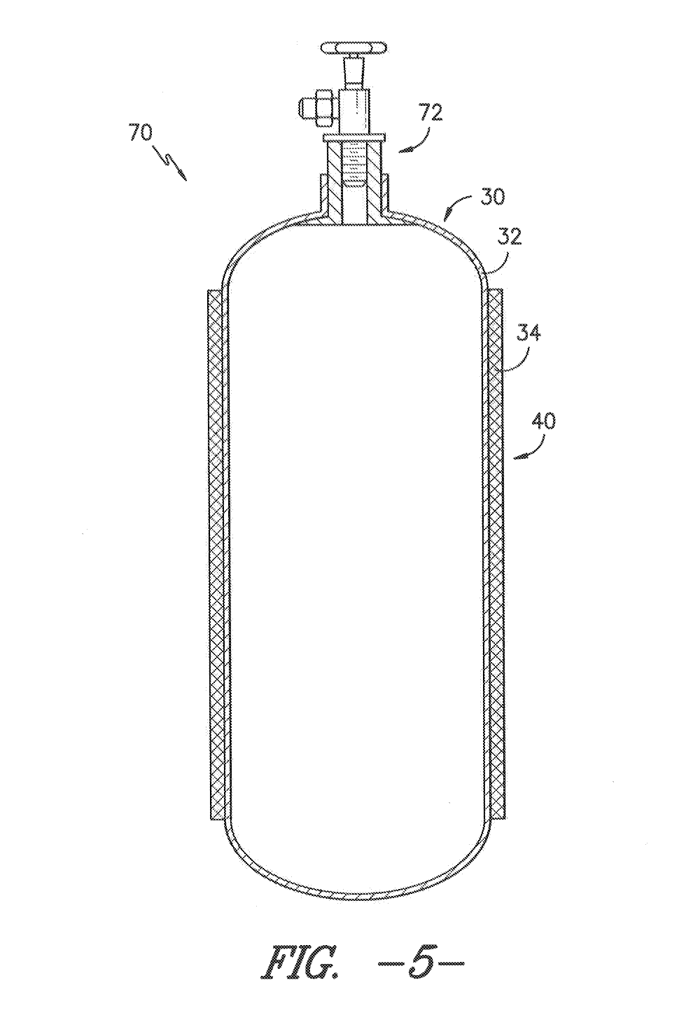

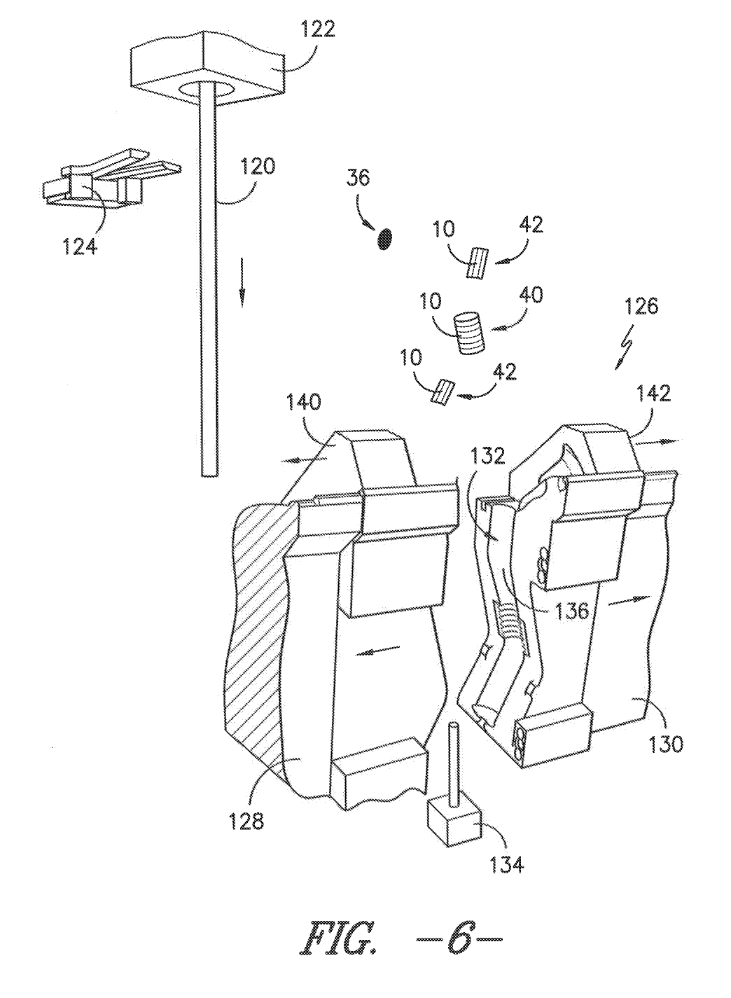

FIGS. 3 and 4 illustrate various embodiments of tubular members which may include composite components 30 according to the present disclosure. FIG. 3 illustrates one embodiment wherein the composite component 30 is a tubular component that forms a single layer tubular member 50. The single layer may be the composite component 30, which may include the inner and outer layers 32, 34 bonded together as discussed above. Distinctions between the inner and outer layers 32, 34 are not shown in FIG. 3 for illustrative purposes. The tubular member 50 as shown is thus a single layer conduit that is blow molded as discussed herein. As shown, the conduit extends in multiple directions leading to a relatively complex shape. For instance, before the blow molded inner layer 32 can solidify during forming of the component 30, the angular displacements as shown in FIG. 3 can be formed into the component 30. The conduit includes angular displacement changes at 52, 54 and 56. The conduit may be, for instance, a component that may be used in the exhaust system of a vehicle or the fuel system of the vehicle. For example, the conduit can form a filler tube for conveying gasoline from a fuel filler neck to a gasoline tank.

FIG. 4 illustrates another embodiment wherein the composite component 30 is a tubular component that is included as a layer in a multi-layer tubular member 60. This layer may include the inner and outer layers 32, 34 bonded together as discussed above. Distinctions between the inner and outer layers 32, 34 are not shown in FIG. 4 for illustrative purposes. The tubular member 60 as shown is thus a multi-layer pipe. The pipe may be, for example, utilized in oil and gas transport applications. For example a pipe utilized as a riser, flowline, tie-in, or in another suitable pipeline application. Additionally or alternatively, the pipe may be utilized in any suitable applications outside of oil and gas transport applications. The composite component 30 can be the inner layer 62, as shown, or an intermediate layer 64 or outer layer 66. The layers may be bonded to each other or unbonded. Further, it should be understood that a multi-layer tubular member according to the present disclosure is not limited to three layers, and may include two, four, or more distinct layers.

The other layers, such as the outer layer 66 and the intermediate layer 64 in the embodiment shown, can be formed from any suitable materials. In some embodiments, the other layers may be formed from thermoplastic materials that are the same or different than the thermoplastic material that forms the composite component 30. In other embodiments, the other layers may be formed from thermosets, metals, ceramics, or another other suitable materials.

FIG. 5 illustrates another embodiment wherein the composite component 30 is a pressure vessel 70 which may include the inner and outer layers 32, 34 bonded together as discussed above. The inner layer 32 and outer layer 34, which in this embodiment is a sleeve 40, are shown. The pressure vessel 70 may further include, for example, a valve 72 for the inlet and exhaust of fluid into the pressure vessel.

In other embodiments, a composite component 30 according to the present disclosure may, for example, form a component for use in the transportation field. By way of example and without limitation, automotive components of the fuel system, the HVAC system, the engine cooling system, as well as interior and exterior portions of the vehicle body can be formed according to a process that includes blow molding the composite component as discussed herein. Specific examples include struts, supports (e.g., radiator supports), grill guards, floor pans, trunk flooring, inner pillars, fuel filler necks, fuel tanks, air ducts, running board assemblies, etc.

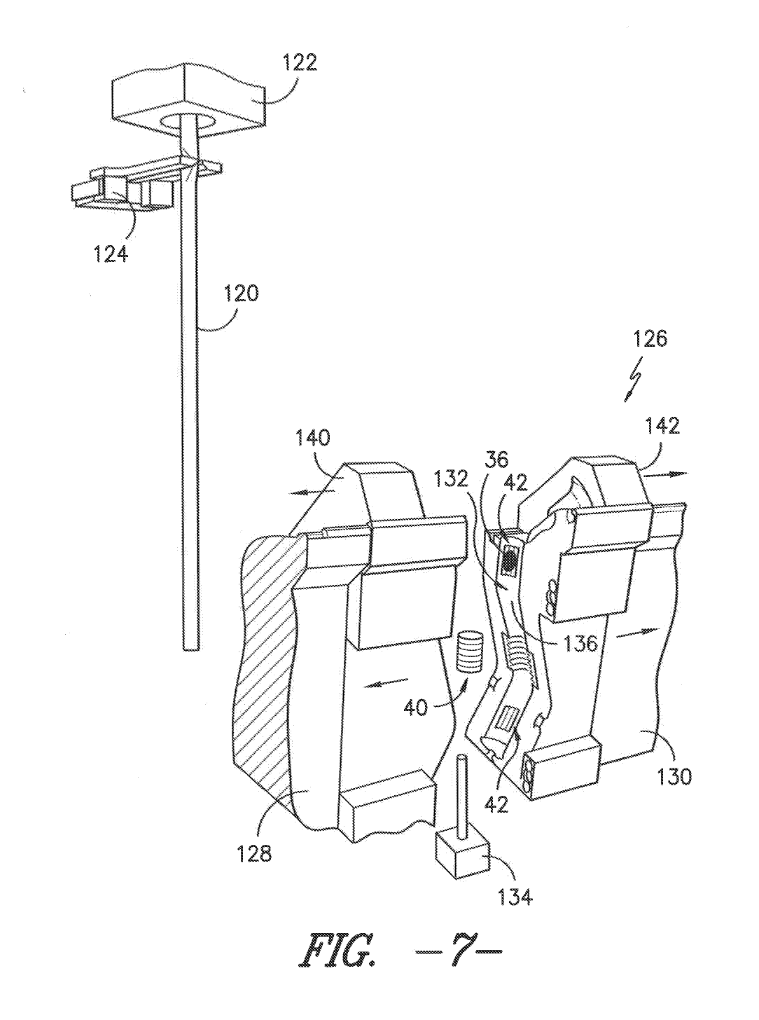

As discussed, composite components 30 according to the present disclosure are formed by blow molding. Specifically, the inner layer 32 may be blow molded. Tapes 10 forming the outer layer 34 may be bonded to the inner layer 32 during blow molding of the inner layer 32. For example, and as shown in FIGS. 6 through 10, tapes 10 may be provided in the mold utilized for blow molding of the inners layer 32. The parison forming the inner layer 32 may be feed into the mold, and may be blow molded. Contact and pressure between the inner layer 32 and tapes 10 during blow molding may facilitate bonding thereof and forming of the bonded inner and outer layers 32, 34 of the composite component 30. Any suitable blow molding processes, such as continuous and intermittent extrusion blow molding, injection blow molding, and stretch blow molding, can be utilized, 3D blow molding, dual process overmolding, and so forth are likewise encompassed herein.

One blow molding process is illustrated sequentially in FIGS. 6 through 10. Referring to FIG. 6, for instance, a thermoplastic material 22 is first heated and extruded into a parison 120 using a die 122 attached to an extrusion device. As shown, the parison 120 is extruded into a downward direction. When the parison 120 is formed as shown in FIG. 6, the material should have sufficient melt strength to prevent gravity from undesirably elongating portions of the parison and thereby forming non-uniform wall thicknesses and other imperfections. On the other hand, the melt elongation must also be sufficiently high to allow for processibility of the material. Thus, there must be a balance between melt strength and melt elongation such that the material can be processed while maintaining uniform wall thickness. In other words, the engineering stress must be sufficiently high at a high percent strain to allow for processibility of the material.

As shown in FIG. 6, the parison 120 is extruded adjacent a clamping mechanism 124 which is typically attached to a robotic arm. Also positioned to receive the parison 120 is a molding device 126. In the embodiment illustrated, the molding device 126 includes a first portion 128 and a second portion 130 that together combine to form a three-dimensional mold cavity 132. In the embodiment illustrated both portions 128 and 130 of the molding device move toward and away from each other. In an alternative embodiment, however, one portion may remain stationary while only the other portion moves. A molding device may also include more than two portions, as is known.

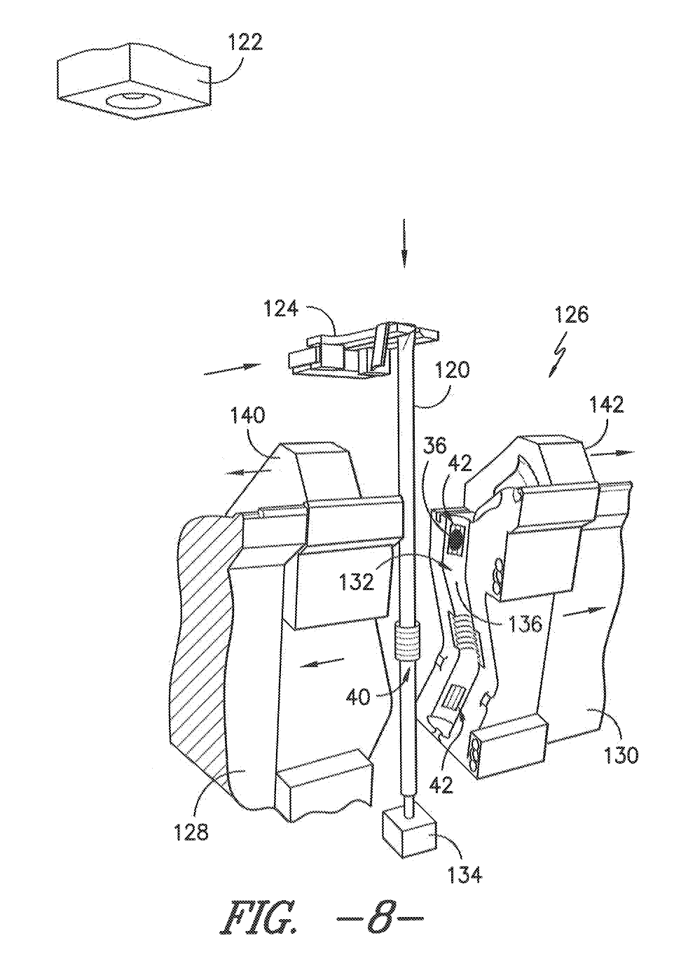

As further shown in FIG. 6, one or more continuous fiber reinforced tapes 10 may additionally be provided. The tapes 10 may be, for example, formed into sleeves 40 or patches 42. As shown in FIG. 7, the tapes 10 may be inserted into the molding device 126, such as within the mold cavity 132. In exemplary embodiments, the tapes 10 may be positioned such that they are between the parison 120 and an inner wall 136 of the molding device 126, as shown. In exemplary embodiment, as discussed above, the tapes 10 may be located in the molding device 126 such that one or more tapes 10 provide local reinforcement to one or more predetermined vulnerable portions of the inner layer 32 and composite component 30 formed during blow molding.

As further shown in FIGS. 6 and 7, an insert 36 may be provided in the mold device 126. The insert 36 may be positioned in the mold device 126 such that a tape 10 is located to reinforce the insert 36 in the final component 30, as discussed above.

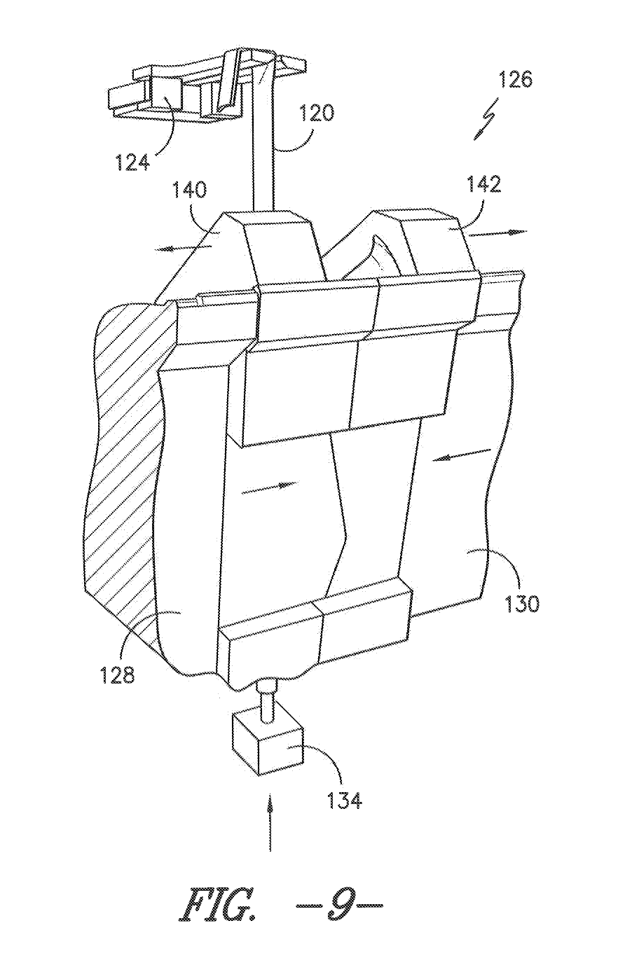

Referring still to FIG. 7, the clamping mechanism 124 may engage a top of the parison 120 after the parison 120 has reached a desired length. As shown in FIG. 8, the clamping mechanism then moves the parison into a position so that the parison can interact with the molding device 126. The clamping mechanism 124 can be moved with the aid of a robotic arm. In embodiments wherein a tape 10 is provided as a sleeve 40, the parison 120 may be inserted through the sleeve 40 as shown. Patches 42 may be provided on the inner walls 136 of the molding device 126.

As can be appreciated, a certain period of time elapses from formation of the parison 120 to clamping and moving the parison 120 into engagement with the molding device 126. During this stage of the process, the melt strength of the thermoplastic material should be high enough such that the parison 120 maintains its shape during movement. The thermoplastic material should also be capable of remaining in a semi-fluid state and not solidifying too rapidly before blow molding commences.

As shown in FIG. 8, the robotic arm also engages the bottom of the parison 120 with a fluid supply device 134 which is used during blow molding.

Referring to FIG, 9, once the parison 120 has been moved into position, the first portion 128 and the second portion 130 of the molding device 126 move together such that the parison 120 partially extends through the mold cavity 132.

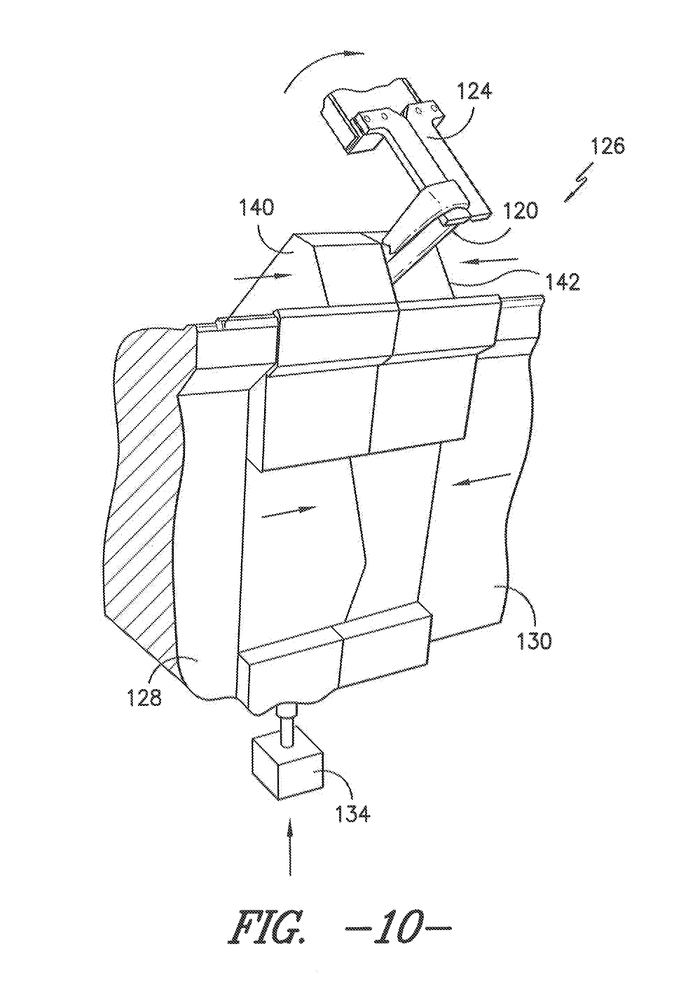

As shown in FIG. 9, the first portion 128 includes a top section 140 and the second portion 130 includes a top section 142. In the embodiment illustrated, the bottom sections of the molding device 126 first close leaving the top sections 140 and 142 open. In this manner, the parison 120 can first engage the bottom portion of the molding cavity 132. The clamping device 124 can then robotically move the top of the parison prior to closing the top sections 140 and 142 of the molding device. Once the clamping mechanism is properly located, as shown in FIG. 10, the top sections of the molding device close such that the parison extends the entire length of the mold cavity.

Having separately movable top sections as shown in FIGS. 9 and 10 are needed in some molding applications when complex shapes are being formed. Having separate sections of the mold surround the parison at different times allows a robotic arm to continue to manipulate the parison in order to place in the resulting part angular displacements.

Once the top sections 140 and 142 of the molding device 126 are closed as shown in FIG. 10, a gas, such as an inert gas, is fed into the parison 120 from the gas supply 134. The gas supplies sufficient pressure against the inner walls 136 of the parison such that the parison conforms to the shape of the mold cavity 132. Further, this pressure facilitates bonding of the parison 120, which forms the inner layer 32, with the tapes 10, which form the outer layer 34, during blow molding.

After blow molding, the finished component 30 is then removed and used as desired. In one embodiment, cool air can be injected into the molded part for solidifying the component prior to removal from the molding device 126.

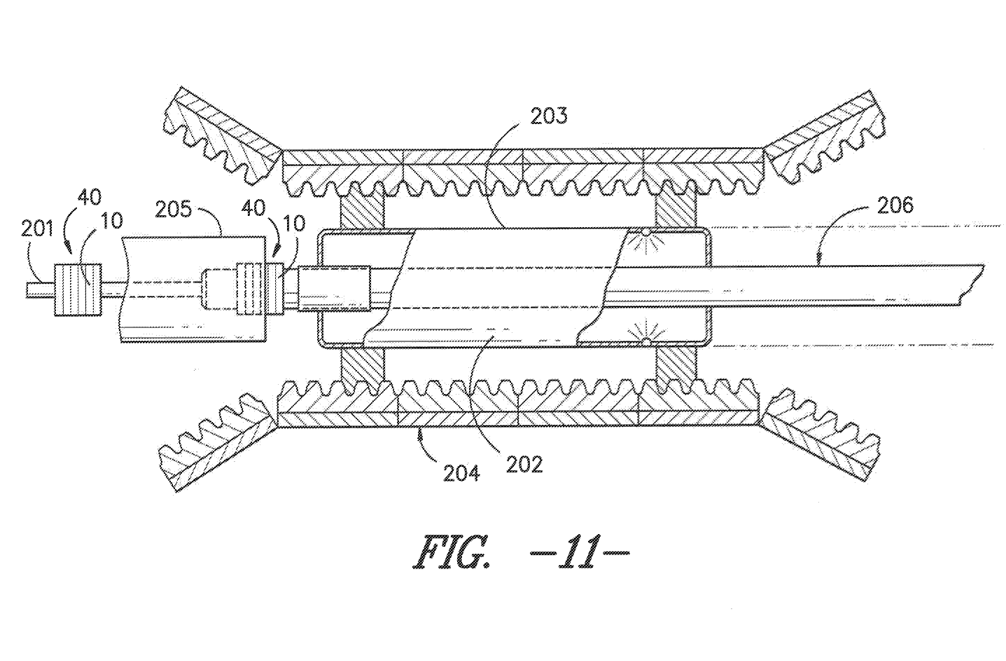

Blow molding processes are not limited to robotic 3-D blow molding methodology as illustrated in FIGS. 6-10, however, and other blow molding processes may alternatively be utilized in forming a component 30. By way of example, in one embodiment, a continuous blow molding process can be used to form larger items, such as long tubular components as may be useful in piping applications. FIG. 11 presents a schematic illustration of one method as may be utilized in forming a long tubular component according to a continuous blow molding process. In a continuous process, a stationary extruder (not shown) can plasticize and force the molten thermoplastic composition through a head to form a continuous parison 201. An accumulator 205 can be used to support the parison and prevent sagging prior to molding. Tapes 10 can be inserted into the mold device, such that the tapes 10 surround or are located proximate to desired locations on the parison 201. Such insertion can be performed simultaneously with or prior to feeding of the parison 201 into a mold device. The parison 201 may be fed to a mold device formed of articulated sections 202, 203 that travel in conjunction with the continuous parison on a mold conveyor assembly 204. Air under pressure is applied to the parison to blow mold the parison within the mold, and to bond the parison 201 and tapes 10 together. After the composite component 30 has been molded and sufficiently cooled within the mold device as the mold device and composite composition travel together, the mold segments are separated from one another and the formed section of the component (e.g., the pipe) 206 is removed from the conveyor.

In another embodiment, 3-D suction blow molding techniques may be utilized. For example, in some embodiments, tapes 10 in the form of sleeves 40 and/or patches 42, as well as inserts 36, may be inserted in a mold device. The mold device may then be closed. A parison may then be fed into the closed mold device through a feed aperture in the mold device via suction, and blow molded therein.

In another embodiment, standard 2-D blow molding may be utilized. For example, in some embodiments, tapes 10 in the form of sleeves 40 and/or patches 42, as well as inserts 36, may be initially provided on a parison outside of the mold device. The parison may, for example, be filled with air sufficient such that the parison supports the sleeves 40 and/or patches 42 and/or inserts 36. The tapes 10 and inserts 36 may be then be inserted into the mold device with the parison as the parison is fed into the mold device. Alternatively, the tapes 10 and/or inserts 36 may be inserted into the mold device, and the parison then fed into the mold device. Blow molding may then take place.

It should be noted that when utilizing any suitable blow molding technique, such as those discussed herein, tapes 10 and inserts 36 can be provided on the parison before the parison is fed into a mold device and/or in the mold device before the parison is fed therein. When tapes 10 and/or inserts 36 are held in a mold device before the parison is provided therein, they may be held due to the mold device geometry, or through use of a vacuum, or through any other suitable device or technique.

The material forming the blow molded inner layer 32 can be constant throughout the entire component or only a portion of the component. For instance, when considering a component having a large aspect ratio (L/D>1), such as a tubular member, the inner layer 32 can be formed such that the thermoplastic material extends along a section of the inner layer 32 and an adjacent section can be formed of a different composition, for instance a different thermoplastic material, Such an inner layer 32 can be formed by, e.g., altering the material that is fed to a blow molding device during a formation process. The inner layer 32 can include an area in which the two materials are mixed that represents a border region between a first section and a second section formed of different materials. An inner layer 32 can include a single section formed of the thermoplastic material or a plurality of sections, as desired. Moreover, other sections of a component can be formed of multiple different materials. By way of example, when considering a tubular component such as a fluid conduit, both ends of the inner layer 32 can be formed of a first thermoplastic material and a center section can be formed of a less flexible second thermoplastic material, Thus, the more flexible ends can be utilized to tightly affix the component to other components of a system. Alternatively, a center section of an inner layer 32 could be formed from a more flexible thermoplastic composition, which can improve flexibility of the component in that section, making installation of the component easier.

The present disclosure thus provides blow molded composite components with advantageous reinforcement features. As discussed, an outer reinforcement layer comprising continuous fiber reinforced thermoplastic tapes 10 is bonded to an inner blow molded layer during the blow molding process. Bonding of the outer layer to the inner layer during the blow molding process is particularly advantageous, as it allows for efficient forming of the resulting composite component. Further, the present disclosure advantageously provides targeted localized reinforcement of the resulting composite components.

These and other modifications and variations to the present disclosure may be practiced by those of ordinary skill in the art, without departing from the spirit and scope of the present disclosure. In addition, it should be understood the aspects of the various embodiments may be interchanged, either in whole or in part. Furthermore, those of ordinary skill in the art will appreciate that the foregoing description is by way of example only, and is not intended to limit the disclosure.

What is claimed is:

1. A method for forming a composite component, the method comprising:
inserting a continuous fiber reinforced thermoplastic tape into a molding device;
feeding a parison into the molding device, the parison comprising a thermoplastic material; and
blow molding the parison within the molding device such that the parison bonds with the tape, forming the composite component.

2. The method of claim 1, wherein the tape is disposed in the molding device between the parison and an inner wall of the molding device.

3. The method of claim 1, further comprising forming the tape into a sleeve, and wherein the parison is fed into the sleeve.

4. The method of claim 1, further comprising forming the tape into a patch.

5. The method of claim 1, wherein the tape is located in the molding device such that it provides local reinforcement to a predetermined vulnerable portion of the composite component.

6. The method of claim 1, further comprising providing an insert in the molding device, at least a portion of the insert disposed between the tape and the parison.

7. The method of claim 1, wherein the thermoplastic material forming the parison is the same as a thermoplastic material utilized to form the tape.

8. The method of claim 1, wherein the continuous fibers of the tape are one of glass fibers, carbon fibers, or aramid fibers.

9. The method of claim 1, wherein the parison further comprises a plurality of fibers embedded in the thermoplastic material.

10. The method of claim 9, wherein the fibers are long fibers.

11. A composite component comprising:
a blow molded inner layer comprising a thermoplastic material; and
an outer layer bonded to the inner layer during blow molding of the inner layer, the outer layer comprising a continuous fiber reinforced thermoplastic tape.

12. The composite component of claim 11, wherein the composite component is formed by a process comprising:
inserting the continuous fiber reinforced thermoplastic tape into a molding device:
feeding a parison into the molding device, the parison formed from the thermoplastic material; and
blow molding the parison within the molding device such that the parison bonds with the tape, forming the composite component.

13. The composite component of claim 11, wherein the outer layer is a sleeve.

14. The composite component of claim 11, wherein the outer layer is a patch.

15. The composite component of claim 11, wherein the inner layer comprises a predetermined vulnerable portion, and wherein at least a portion of the tape is bonded to the predetermined vulnerable portion.

16. The composite component of claim 11, further comprising an insert, at least a portion of the insert disposed between the inner layer and the outer layer.

17. The composite component of claim 11, wherein the composite component is a tubular component.

18. The composite component of claim 17, wherein the tubular component is a pipe.

19. The composite component of claim 11, wherein the composite component is a pressure vessel.
